(19) United States
(12) Patent Application Publication
(10) Pub. No.: US 2015/0312622 A1
(43) Pub. Date: Oct. 29, 2015

(54) PROXIMITY DETECTION OF CANDIDATE COMPANION DISPLAY DEVICE IN SAME ROOM AS PRIMARY DISPLAY USING UPNP

(71) Applicant: SONY CORPORATION, TOKYO (JP)

(72) Inventor: Brant Candelore, San Diego, CA (US)

(73) Assignee: SONY CORPORATION, TOKYO (JP)

(21) Appl. No.: 14/262,051

(22) Filed: Apr. 25, 2014

(51) Int. Cl. H04N 21/436; H04N 21/81; H04N 21/41; H04N 21/4722; H04N 21/485

(52) U.S. Cl. CPC H04N 21/43615; H04N 21/4722; H04N 21/485; H04N 21/4122; H04N 21/4126; H04N 21/8133

(57) ABSTRACT

In one aspect, a first device includes a storage medium bearing instructions and a processor configured for accessing the storage medium to execute the instructions to configure the processor for determining the location of the first device, determining the location of a second device at least partially based on communication of the first device with the second device using Universal Plug and Play (UPnP) communication, comparing the physical location of the first device to the physical location of the second device to determine whether the first and second devices are both within a predefined area, and presenting a user interface (UI) on a display of the first device responsive to determining that the first and second devices are both within the predefined area. The UI enables a user to provide a command to the second device to present ancillary content related to primary content which the first device is to present.

### I. FIELD OF THE INVENTION

The application relates generally to determining that a candidate companion display device is in the same room as a primary display using location information sent using Universal Plug and Play (UPnP) communication.

### II. BACKGROUND OF THE INVENTION

A computer ecosystem, or digital ecosystem, is an adaptive and distributed socio-technical system that is characterized by its sustainability, self-organization, and scalability. Inspired by environmental ecosystems, which consist of biotic and abiotic components that interact through nutrient cycles and energy flows, complete computer ecosystems consist of hardware, software, and services that in some cases may be provided by one company, such as Sony. The goal of each computer ecosystem is to provide consumers with everything that may be desired, at least in part services and/or software that may be exchanged via the Internet. Moreover, interconnectedness and sharing among elements of an ecosystem, such as applications within a computing cloud, provides consumers with increased capability to organize and access data and presents itself as the future characteristic of efficient integrative ecosystems.

Two general types of computer ecosystems exist: vertical and horizontal computer ecosystems. In the vertical approach, virtually all aspects of the ecosystem are owned and controlled by one company, and are specifically designed to seamlessly interact with one another. Horizontal ecosystems, one the other hand, integrate aspects such as hardware and software that are created by other entities into one unified ecosystem. The horizontal approach allows for greater variety of input from consumers and manufactures, increasing the capacity for novel innovations and adaptations to changing demands.

An example ecosystem that is pertinent here is a home entertainment ecosystem that includes a TV and various nearby display devices such as wireless communication devices.

### SUMMARY OF TILE INVENTION

As understood herein, to pair the TV with a device in the home ecosystem for use as a “companion” device to the TV, typically a user must select a device from a long list of ecosystem devices, in the home and in many cases those in neighboring homes, which might have been discovered wirelessly. Usually, it is up to the user (a human) to figure out which devices are in the home let alone the same room.

Present principles are directed to allowing a primary display device (PDD) such as an audio video display device (AVDD) such as a TV to discover candidate companion screen devices (CCSD), e.g., tablet computers, wireless telephones, and the like that are not just present in the home ecosystem but that also are in the same room as the PDD. This promotes intelligently selecting which one of multiple CCSDs to select for presenting ancillary content related to primary content being shown on the PDD, as CCSDs outside the room in which the PDD is located are not as useful or even desirable to show ancillary content when the user of the outside-the-room device cannot see the PDD. The PDD can send a CCSD in the same room as the PDD a message about whether the user desires to have ancillary data presented on the CCSD.

It should be noted that the PDD may be established by a device with a relatively small display such as a wireless tablet, if it is the device of focus with content that is playing. In this scenario, the CCSD may be established by, for example, a larger screen TV without affecting present principles.

Accordingly, in one aspect a first device includes at least one computer readable storage medium bearing instructions executable by a processor. The first device also includes at least one processor configured for accessing the computer readable storage medium to execute the instructions to configure the processor for setting the physical location of the first device, determining the physical location of a second device at least partially based on communication of the first device with the second device using Universal Plug and Play (UPnP) communication, comparing the physical location tag of the first device to the physical location tag of the second device to determine whether the first and second devices are both within a predefined area, and presenting a user interface (UI) on a display of the first device responsive to determining that the first and second devices are both within the predefined area. The UI enables a user to provide a command to the second device to present ancillary content related to primary content which the first device is to present.

Further, the UI may enable the user to configure the second device to present the ancillary content by things such as enabling the user to cause a display of the second device to assume a powered on configuration, enabling the user to indicate a location for the ancillary content which the second device is to access to present the ancillary content, and/or enabling the user to configure the first device to provide the ancillary content to the second device.

In addition, in some embodiments the predefined area may be established at least in part based on the dimensions of a room in which the first device is disposed, and the location of the second device may be determined at least in part based on receipt of a physical location tag from the second device using UPnP communication. Thus, if desired the location tag that is received may include information pertaining to a room in which the second device is disposed.

Still further, the determining the physical location of the first device may include determining a room in which the first device is disposed. The determining a room in which the first device is disposed may be based at least partially on input from a user through a user interface that allows a selection from pre-set choices and/or ones that can be customized by the user. The physical location tag in the first and/or second device may also be set by the detection of a location beacon delivered using a Bluetooth low energy (BLE) signal. The at least one BLE signal may in some embodiments be at least one iBeacon signal.

In another aspect, a method includes enabling Universal Plug and Play (UPnP) communication of location information between a first device and a second device where the physical location information pertains to the location of at least one of the first device and the second device. The method also includes, responsive to determining at least partially based on the location information that the first and second devices are both within a first area, presenting a user interface (UI) on a display enabling a user to cause one of the first and second devices to present first content related to but different from second content which the other of the first and second devices is presenting or will be presenting.

In still another aspect, a first device includes at least one computer readable storage medium bearing instructions executable by a processor. The first device also includes at least one processor configured for accessing the computer readable storage medium to execute the instructions to configure the processor for transmitting physical location information over a Universal Plug and Play (UPnP) communication link at least to a second device, where the location information pertains to the location of the first device. The processor is also configured to execute the instructions for receiving from the first device ancillary content related to primary content which the second device is or will be presenting, and/or receiving from the second device a link to the ancillary content for presentation thereof on the first device.

In yet another aspect, a physical location tag is sent as part of Universal Plug and Play protocol that is set by a user and used by devices to determine whether they are located in the same room.

The details of the present invention, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIGS. 2-4 are flow charts showing example algorithms according to present principles; and

FIGS. 5-10 are example user interfaces (UIs) according to present principles.

### DETAILED DESCRIPTION OF THE PREFERRED EMBODIMENT

This disclosure relates generally to computer ecosystems including aspects of consumer electronics (CE) device based user information in computer ecosystems. A system herein may include server and client components, connected over a network such that data may be exchanged between the client and server components. The client components may include one or more computing devices including portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, operating systems from Microsoft, or a Unix operating system, or operating systems produced by Apple Computer or Google. These operating environments may be used to execute one or more browsing programs, such as a browser made by Microsoft or Google or Mozilla or other browser program that can access web applications hosted by the Internet servers discussed below.

Servers may include one or more processors executing instructions that configure the servers to receive and transmit data over a network such as the Internet. Or, a client and server can be connected over a local intranet or a virtual private network.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires. Such connections may include wireless communication connections including infrared and radio.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

Now specifically referring to FIG. 1, an example ecosystem 10 is shown, which may include one or more of the example devices mentioned above and described further below in accordance with present principles. The first of the example devices included in the system 10 is an example primary display device, and in the embodiment shown is an audio video display device (AVDD) 12 such as but not limited to an Internet-enabled TV. Thus, the AVDD 12 alternatively may be an appliance or household item, e.g. computerized Internet enabled refrigerator, washer, or dryer. The AVDD 12 alternatively may also be a computerized Internet enabled (“smart”) telephone, a tablet computer, a notebook computer, a wearable computerized device such as e.g. computerized Internet-enabled watch, a computerized Internet-enabled bracelet, other computerized Internet-enabled devices, a computerized Internet-enabled music player, computerized Internet-enabled head phones, a computerized Internet-enabled implantable device such as an implantable skin device, etc. Regardless, it is to be understood that the AVDD 12 is configured to undertake present principles (e.g. communicate with other CE devices to undertake present principles, execute the logic described herein, and perform any other functions and/or operations described herein).

Accordingly, to undertake such principles the AVDD 12 can be established by some or all of the components shown in FIG. 1. For example, the AVDD 12 can include one or more displays 14 that may be implemented by a high definition or ultra-high definition flat screen and that may be touch-enabled for receiving user input signals via touches on the display. The AVDD 12 may include one or more speakers 16 for outputting audio in accordance with present principles, and at least one additional input device 18 such as e.g. an audio receiver/microphone for e.g. entering audible commands to the AVDD 12 to control the AVDD 12. The example AVDD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface. It is to be understood that the processor 24 controls the AVDD 12 to undertake present principles, including the other elements of the AVDD 12 described herein such as e.g. controlling the display 14 to present images thereon and receiving input therefrom. Furthermore, note the network interface 20 may be, e.g., a wired or wireless modem or router, or other appropriate interface such as, e.g., a wireless telephony transceiver, or Wi-Fi transceiver as mentioned above, etc.

In addition to the foregoing, the AVDD 12 may also include one or more input ports 26 such as, e.g., a USB port to physically connect (e.g. using a wired connection) to another CE device and/or a headphone port to connect headphones to the AVDD 12 for presentation of audio from the AVDD 12 to a user through the headphones. The AVDD 12 may further include one or more tangible computer readable storage medium 28 such as disk-based or solid state storage. Also in some embodiments, the AVDD 12 can include a position or location receiver such as but not limited to a cellphone receiver, GPS receiver and/or altimeter 30 that is configured to e.g. receive geographic position information from at least one satellite or cellphone tower and provide the information to the processor 24 and/or determine an altitude at which the AVDD 12 is disposed in conjunction with the processor 24. However, it is to be understood that that another suitable position receiver other than a cellphone receiver, GPS receiver and/or altimeter may be used in accordance with present principles to e.g. determine the location of the AVDD 12 in e.g. all three dimensions.

Continuing the description of the AVDD 12, in some embodiments the AVDD 12 may include one or more cameras 32 that may be, e.g., a thermal imaging camera, a digital camera such as a webcam, and/or a camera integrated into the AVDD 12 and controllable by the processor 24 to gather pictures/images and/or video in accordance with present principles. Also included on the AVDD 12 may be a Bluetooth module 34 and other Near Field Communication (NFC) element 36 for communication with other devices using Bluetooth and/or NFC technology, respectively. An example NFC element can be a radio frequency identification (RFID) element. Note that the elements 34, 36, like other appropriate elements herein described, may be incorporated within a housing or chassis of the associated device or be provided as a universal serial bus (USB)2/3 dongle device.

With respect to the Bluetooth module 34, it may be implemented as a Bluetooth Low Energy (BLE) module and/or a Bluetooth 4.0 module that implements communications using one or more of BLE systems, standard Bluetooth systems, and/or iBeacon systems specifically. As understood herein, BLE operates in the same spectrum range (the 2.400 GHz-2.4835 GHz band) as classic Bluetooth technology, but uses a different set of channels. Instead of Bluetooth's seventy nine 1-MHz channels, BLE employ forty 2-MHz channels. BLE sends data within a channel using Gaussian frequency shift modulation with a one megabyte per second data rate and a maximum transmission power of ten milliWatts (10 mW).

Note that a Bluetooth beacon 35 is also shown, which may be e.g. a so-called “stand-alone” device as shown (although present principles recognize it may be incorporated into any of the devices described herein). It is to thus be understood that the beacon 35 may transmit (e.g. broadcast) signals which may be received by devices having a Bluetooth module such as the module 34 enabled to receive Bluetooth signals. It is to be further understood that the signals transmitted by the beacon 35 may contain data pertaining to the location (e.g. a room of a structure) in which the beacon 35 is disposed in accordance with present principles, such as location tags which will be described further below. In some embodiments, the beacon 35 may specifically be a beacon operating per iBeacon standards and/or protocols to thus transmit iBeacon signals including location information.

Additionally, the AVDD 12 may include a Universal Plug and Play (UPnP) communication element 39, and thus the AVDD 12 is understood to be configured to communicate and exchange information over e.g. the network 22 using UPnP communication and/or protocols with other devices that themselves have respective UPnP communication elements (such as e.g. the CE devices 44 and 46 to be described shortly). In any case, it is to be understood that device information for other devices on the network 22 can be determined by the AVDD 12 based on information the AVDD 12 receives pertaining to the other networked devices as gathered and/or received by the AVDD 12 using UPnP communication and/or protocols. In some embodiments, UPnP uses the Simple Service Discovery Protocol (SSDP) to allow devices to discover applications and devices in the local network. To learn more about a particular device, the device's description is retrieved. The UPnP Device Description Document includes information such as manufacturer name, model name and number, and serial number. It is to be understood that the Device Description Document may have a proposed additional information tag for physical location. This tag may be configured by the user of the AVDD 12 on initial set-up and/or may be set by receiving a signal from a location beacon with that information. The tag would consist of XML and be human readable, for example, the user may initialize the AVDD 12 with a location tag of “Master Bedroom”, “Livingroom”, “Bedroom 1”, or “Office”. In some scenarios, the physical location may be customizable, e.g. “John's Bedroom” or “Susan's Bedroom”.

In addition to the foregoing, the AVDD 12 may include one or more auxiliary sensors 37 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the processor 24. The AVDD 12 may include still other sensors such as e.g. one or more climate sensors 38 (e.g. barometers, humidity sensors, wind sensors, light sensors, temperature sensors, etc.) and/or one or more biometric sensors 40 providing input to the processor 24. In addition to the foregoing, it is noted that the AVDD 12 may also include an infrared (IR) transmitter and/or IR receiver and/or IR transceiver 42 such as an IR data association (IRDA) device. A battery (not shown) may be provided for powering the AVDD 12.

Still referring to FIG. 1, in addition to the AVDD 12, the system 10 may include one or more other CE device types that may establish candidate companion screen devices for the primary display device established by the AVDD 12. In one example, a first candidate companion screen device is established by a first CE device 44 while a second companion screen device may be established by a second CE device 46 which may include similar components as the first CE device 44 and hence will not be discussed in detail. In the example shown, only two CE devices 44, 46 are shown as candidate companion screen devices, it being understood that only one candidate companion screen device or more than two candidate companion screen devices may be used.

In the example shown, to illustrate present principles all three devices 12, 44, 46 are assumed to be members of a home entertainment network in a dwelling or at least to be present in proximity to each other in a location such as a house. However, for illustrating present principles the first CE device 44 is assumed to be in the same room as the AVDD 12 (e.g., as is the beacon 35), bounded by walls illustrated by dashed lines 48, whereas the second CE device 46, while not being necessarily further from the AVDD 12 as is the first CE device 44 and in fact while potentially being closer to the AVDD 12 than is the first CE device 44, is outside the room bounded by the walls 48.

The example non-limiting first CE device 44 may be established by any one of the above-mentioned devices and accordingly may have one or more of the components described below. Specifically, the first CE device 44 may include one or more displays 50 that may be touch-enabled for receiving user input signals via touches on the display. The first CE device 44 may include one or more speakers 52 for outputting audio in accordance with present principles, and at least one additional input device 54 such as e.g. an audio receiver/microphone for e.g. entering audible commands to the first CE device 44 to control the device 44. The example first CE device 44 may also include one or more network interfaces 56 for communication over the network 22 under control of one or more CE device processors 58. Thus, the interface 56 may be, without limitation, a Wi-Fi transceiver, which is an example of a wireless computer network interface. It is to be understood that the processor 58 controls the first CE device 44 to undertake present principles, including the other elements of the first CE device 44 described herein such as e.g. controlling the display 50 to present images thereon and receiving input therefrom. Furthermore, note the network interface 56 may be, e.g., a wired or wireless modem or router, or other appropriate interface such as, e.g., a wireless telephony transceiver, or Wi-Fi transceiver as mentioned above, etc.

In addition to the foregoing, the first CE device 44 may also include one or more input ports 60 such as, e.g., a USB port to physically connect (e.g. using a wired connection) to another CE device and/or a headphone port to connect headphones to the first CE device 44 for presentation of audio from the first CE device 44 to a user through the headphones. The first CE device 44 may further include one or more tangible computer readable storage medium 62 such as disk-based or solid state storage. Also in some embodiments, the first CE device 44 can include a position or location receiver such as but not limited to a cellphone and/or GPS receiver and/or altimeter 64 that is configured to e.g. receive geographic position information from at least one satellite and/or cell tower, using triangulation, and provide the information to the CE device processor 58 and/or determine an altitude at which the first CE device 44 is disposed in conjunction with the CE device processor 58. However, it is to be understood that that another suitable position receiver other than a cellphone and/or GPS receiver and/or altimeter may be used in accordance with present principles to e.g. determine the location of the first CE device 44 in e.g. all three dimensions.

Continuing the description of the first CE device 44, in some embodiments the first CE device 44 may include one or more cameras 66 that may be, e.g., a thermal imaging camera, a digital camera such as a webcam, and/or a camera integrated into the first CE device 44 and controllable by the CE device processor 58 to gather pictures/images and/or video in accordance with present principles.

Also included on the first CE device 44 may be a Bluetooth module 68 and other Near Field Communication (NFC) element 70 for communication with other devices using Bluetooth and/or NFC technology, respectively. An example NFC element can be a radio frequency identification (RFID) element. The Bluetooth module 68 may be substantially similar in configuration and use to the Bluetooth module 34 of the PDD.

Further still, the first CE device 44 may include one or more auxiliary sensors 72 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the CE device processor 58. The first CE device 44 may include still other sensors such as e.g. one or more climate sensors 74 (e.g. barometers, humidity sensors, wind sensors, light sensors, temperature sensors, etc.) and/or one or more biometric sensors 76 providing input to the CE device processor 58. In addition to the foregoing, it is noted that in some embodiments the first CE device 44 may also include an infrared (IR) transmitter and/or IR receiver and/or IR transceiver 78 such as an IR data association (IRDA) device. A battery (not shown) may be provided for powering the first CE device 44. Also note that the first CE device 44 includes a UPnP communication element 79 for communication with e.g. the AVDD 12 and other devices at least as described herein. The second CE device 46 may include some or all of the components shown for the CE device 44.

Now in reference to the afore-mentioned at least one server 80, it includes at least one server processor 82, at least one tangible computer readable storage medium 84 such as disk-based or solid state storage, and at least one network interface 86 that, under control of the server processor 82, allows for communication with the other devices of FIG. 1 over the network 22, and indeed may facilitate communication between servers and client devices in accordance with present principles. Note that the network interface 86 may be, e.g., a wired or wireless modem or router, Wi-Fi transceiver, or other appropriate interface such as, e.g., a wireless telephony transceiver.

Accordingly, in some embodiments the server 80 may be an Internet server, and may include and perform “cloud” functions such that the devices of the system 10 may access a “cloud” environment via the server 80 in example embodiments.

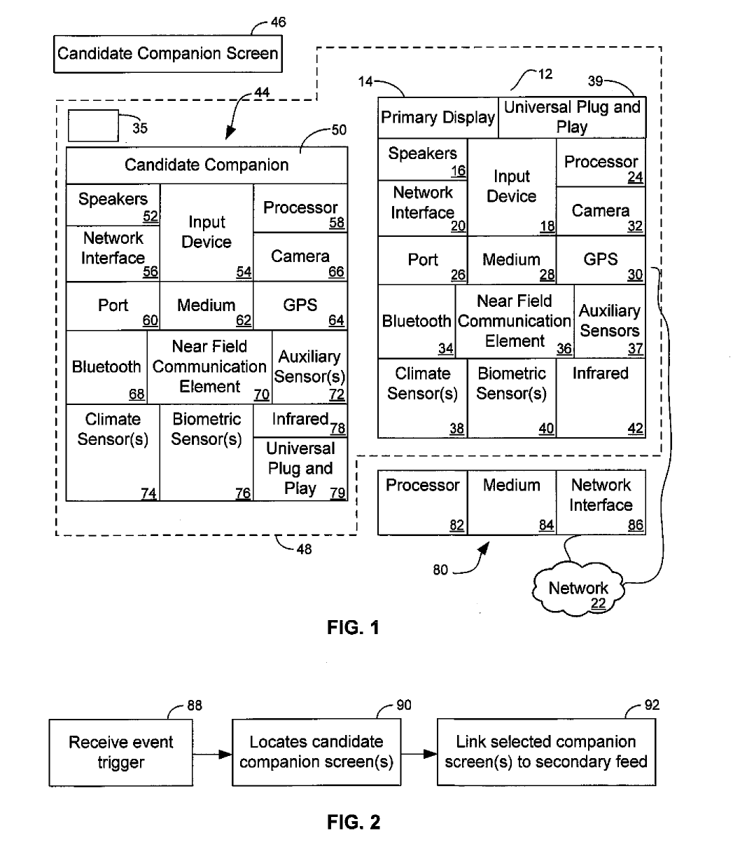

FIG. 2 shows overall logic according to present principles. In some examples an event trigger may be received at block 88 to activate the ensuing logic. For example, a particular actor or product or sound may appear or program change in a broadcast channel being presented on the AVDD 12 as indicated by metadata in the program, or by recognition of demanded images by the AVDD processor 24, or by recognition of sounds presented on the AVDD 12 speakers 16 as detected by the microphone 18 and analyzed by the processor 24 either in a standalone mode and/or by uploading the images/sounds to the cloud server 80 for analysis, which sends the analysis results back to the AVDD 12. Or, using detection principles below the AVDD 12 may recognize that a candidate companion device 44 or 46 has been carried into the room in which the AVDD 12 is disposed, using such recognition as a trigger.

In any case, as set forth further below at block 90 the AVDD 12 locates candidate companion screens that are in the same room as the AVDD 12, screening out candidate companion screens that may be nearby but outside the walls 48. At block 92 one or more candidate companion screens that are detected as being in the same room as the AVDD 12 are provided with ancillary feed(s) related to the program being presented on the AVDD 12 by, e.g., linking the companion screen(s) to a computer site associated with the program being presented on the AVDD 12. This linking may entail simply providing a network address or link from the AVDD 12 to the companion screen which a user can select to cause a network browser to access a computer network site on the home network, on the PDD itself, or on the Internet supplying the ancillary feed/content/data (used interchangeably), or the linking may be more automated, e.g., the AVDD may command the companion screen device to automatically access a particular network site and automatically commence downloading the ancillary feed/content/data without any user action to accomplish this.

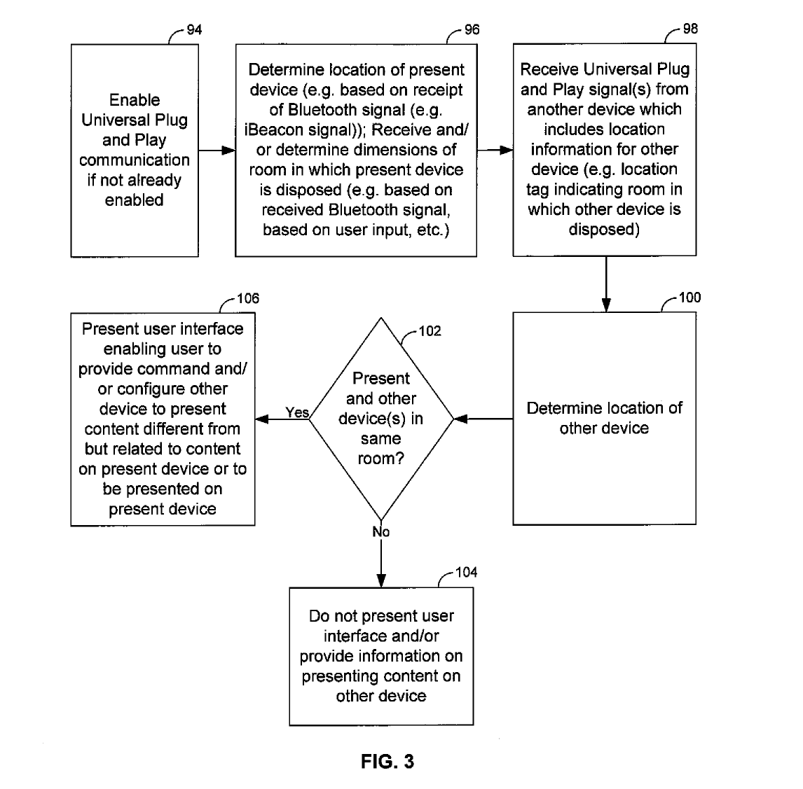

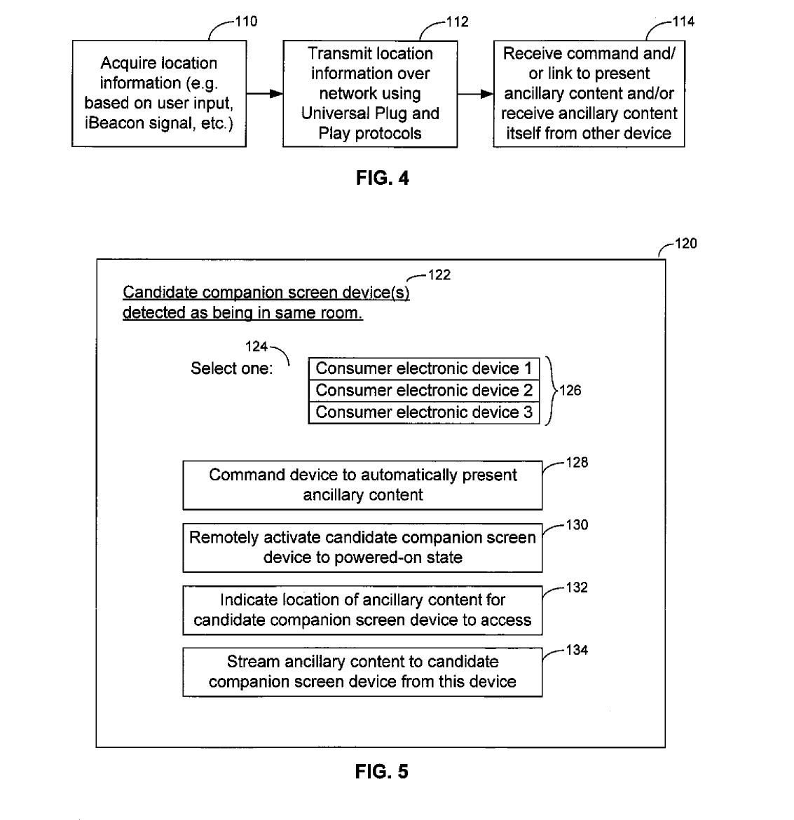

Note that the logic of FIG. 2 may be employed by the CCSD to locate a PDD to which to “throw” content along the lines described above. Accordingly, the logic of FIG. 2 as well as the logic described below in reference to FIGS. 3 and 4 may be undertaken by a CCSD and/or a PDD in non-limiting embodiments.

FIG. 3 illustrates example logic. Commencing at block 94, the device undertaking the logic of FIG. 3 (referred to below as the “present device”) is enabled for UPnP communication if it has not already been so enabled. UPnP communication may be enabled at block 94 e.g. based on device presets, based on the device being initially powered on, based on user input that it be enabled, etc. In any case, the logic then proceeds to block 96 where the logic determines the location of the present device, such as e.g. based on receipt of one or more Bluetooth signals and in some embodiments receipt specifically of one or more iBeacon signals from e.g. an iBeacon signal transmitter (e.g., the beacon 35 described above). In some embodiments, the one or more signals may indicate the location based on location information being provided to the iBeacon signal transmitter by e.g. an administrator of the iBeacon signal transmitter, which is then transmitted to other devices by the signal transmitter through the one or more signals.

However, in addition to or in lieu of the foregoing but also at block 96, the logic may determine the dimensions of a room in which the present device is disposed, which may be based on e.g. information received in the one more or more Bluetooth signals, based on user input, and/or based on e.g. sonar or radar detection of the walls of the room based respectively on e.g. operation of a sonar or radar system on the present device.

From block 96 the logic proceeds to block 98 where the logic receives one or more UPnP signals from another device (referred to below as the “other device,” it being understood that the present device may be a PDD while the other device may be a CCSD, and vice versa). The UPnP signals may include physical location information pertaining to the location of the other device, e.g. as determined by the other device based on the other device receiving one or more iBeacon signals from an iBeacon signal transmitter in accordance with present principles. Furthermore, in example embodiments the location information that is received at block 98 may include a location tag indicating the room in which the other device is disposed.

Still in reference to FIG. 3, after block 98 the logic proceeds to block 100 where the logic determines the physical location of the other device based on the UPnP signal(s) that is received. The logic thereafter moves to decision diamond 102 where the logic determines whether the present device and other device are in the same room as each other based on the location information determined at block 96 and received at block 98. The determination at diamond 102 may be based on e.g. a comparison of the location information determined at block 96 and received at block 98 to determine whether the two indicate at least some of the same location information, such as both indicating in location tags the same room in which they are presently disposed. E.g., the location tag may include a room ID and/or room name based on names or other characters input by a user when configuring a network on which the present and other device are configured to communicate. However, in addition to or in lieu of the foregoing at diamond 102, a user may provide input to the present device that the other device is in the same room (e.g. based on manipulation of a user interface (UI) presented on a display of the present device that is manipulable at least for such purposes).

A negative determination at diamond 102 causes the logic to proceed to block 104 where the logic declines to present a UI such as the one to be described below in reference to FIG. 5, and/or declines to provide information on presenting content on the other device related to content to be presented on the present device. However, an affirmative determination at diamond 102 instead causes the logic to move to block 106, where the logic presents a UI on a display of the present device enabling a user to provide a command and/or configure the other device to present content different from but related to (e.g. complimentary content such as ancillary content) content being presented or to be presented on the present device.

Continuing the detailed description with reference to FIG. 4, it also illustrates example logic to be used in accordance with present principles. The logic of FIG. 4 may be undertaken by e.g. a CCSD. Beginning at block 110, the device undertaking the logic of FIG. 4 acquires location information pertaining to the device's location in a room of a building or other structure in accordance with present principles (e.g., at least partially based on receipt of at least one iBeacon signal, based on user input, etc.).

After block 110, the logic proceeds to block 112 where the logic transmits at least some of the location information that was acquired at block 110 over a universal plug and play (UPnP) communication link and/or using UPnP protocols to at least one other device where the information transmitted using UPnP communication pertains to the location of the device undertaking the present logic. The logic then proceeds to block 114, where the logic waits until a command to present content is received, or other information is received (e.g. configuration information, and/or a link (such as an Internet link) to ancillary content), e.g. from a PDD (e.g. in response to a determination at the PDD that the PDD and the present device are in the same room in accordance with present principles). Also at block 114, the logic may receive the ancillary content itself from the other device such as e.g. receiving a stream of the content over a WiFi link from the other device. Thus, it is to be understood that the content described immediately above in reference to block 114 may be ancillary content related to primary content which the other device is or will be presenting.

Reference is now made to FIG. 5, which shows a UI 120 in accordance with present principles that enables a user to provide a command to and/or configure another device to present content related to other content which is or will be presented on the device presenting the UI 120. The UI 120 includes an indication 122 that one or more CCSD devices have been detected as being in the same room as the e.g. PDD presenting the UI 120 in accordance with present principles. The UI 120 also includes a grouping and/or listing 124 of the one or more devices that have been detected as being in the same room as the PDD as represented by selector elements 126 having text respectively indicating different devices detected to be in the room and associated with the respective selector element. Thus, it is to be understood that each of the selector elements 126 are selectable to automatically without further user input responsive thereto provide a command and/or configure the device associated with the selected selector element to present e.g. ancillary content thereon.

In addition to the foregoing, the UI 120 may also include a selector element 128 selectable to automatically without further user input responsive thereto command a selected CCSD device (e.g. selected from the listing 124) to begin automatically presenting content. The UI 120 also shows a selector element 130, which may be selectable to automatically without further user input responsive thereto power on the CCSD device from the device presenting the UI 120, such as e.g. fully powering on the device and/or powering on its display specifically so that ancillary content may be presented thereon.

Still another selector element 132 may be presented on the UI 120, which may be selectable to automatically without further user input responsive thereto cause transmission by the device presenting the UI 120 of location information to the CCSD for the ancillary content that is to be presented on the CCSD. E.g., selection of the element 132 may cause a link such as a local, remote, and/or cloud file link to be transmitted, and/or an Internet link to the ancillary content to be transmitted. Last, the UI 120 may include a selector element 134 selectable to automatically without further user input responsive thereto stream the ancillary content to the CCSD from the device presenting the UI 120 over e.g. a WiFi link and/or network to which both devices are communicatively connected. In addition to or in lieu of the foregoing, selection of the element 134 may in some embodiments cause the CCSD to automatically without further user input responsive thereto begin streaming the ancillary content from another device and/or location, such as e.g. a third party Internet server, content sharing website, from cloud storage of a user of one or both devices, from an Internet content subscription service, etc.

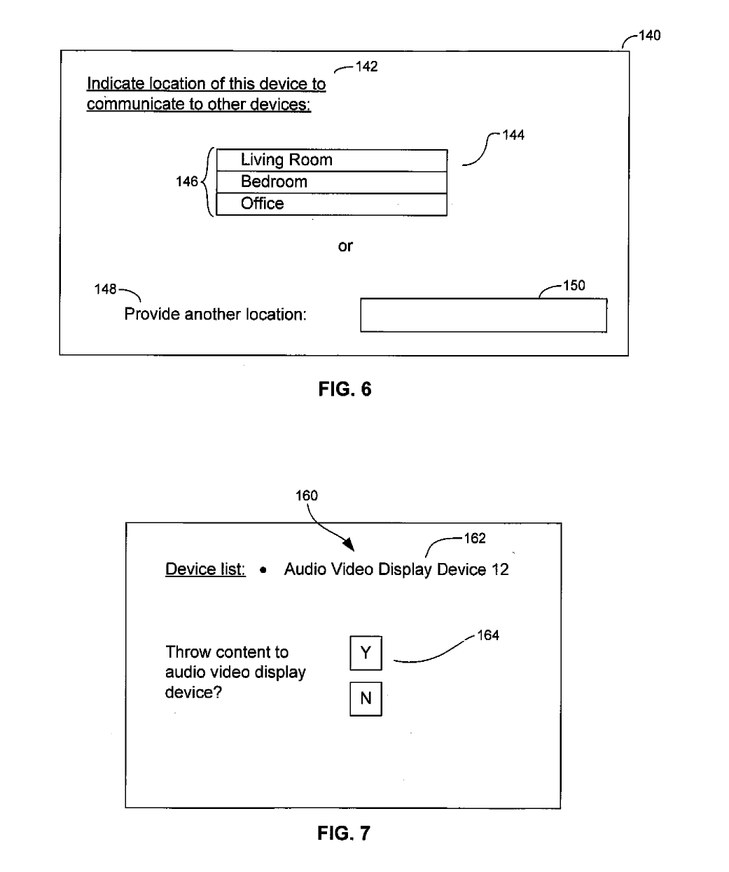

Continuing the detailed description in reference to FIG. 6, it shows a UI 140 which may be presented on a device in accordance with present principles. The UI 140 includes a prompt 142 for the user to indicate a location of the device presenting the UI 140 for communication to one or more other devices in accordance with present principles. Thus, a grouping and/or listing 144 of locations is presented (e.g. different rooms in the same structure) as detected and/or determined based on e.g. network presets and configurations, where each entry in the listing 144 is represented by a respective selector elements 146 having text respectively indicating a room. Thus, it is to be understood that each of the selector elements 146 are selectable to automatically without further user input responsive thereto configure the device presenting the UI 140 to include an indication of the room associated with the selected selector element 146 in location information provided to other devices over e.g. UPnP communication. Note that the listing 144 may dynamically change based on the device's location in the building such that e.g. the listing 144 presents one or more rooms adjacent to or proximate to the device's current location (e.g., if the device cannot with certainty determine a particular room in a building in which the device is disposed) based on e.g. network presets and configurations.

Further, note that the UI 140 also includes an option 148 for the user to input and/or specify (e.g. “manually” using a physical and/or virtual keyboard) a location in which the device presenting the UI 140 is located.

FIG. 7 illustrates an example UI 160 according to present principles. In some embodiments, the UI 160 may be presented on a CCSD. Thus, upon receipt by the CCSD of e.g. a BLE signal from a beacon (e.g. the beacon 35) indicating location information, the CCSD may employ device discovery and/or linking principles over a Wi-Fi or Ethernet communication link using universal plug-and-play (UPnP) in accordance with present principles to provide such location information to other devices on the network.

In any case, the example UI 160 shown in FIG. 7 presents at 162, as a possible target for content and to avoid clutter and confusion on the part of the user, only a PDD that e.g. responded to the CCSD using UPnP communication, sent back its own location information, and/or is determined to be in the same room as the CCSD in accordance with present principles. A selector 164 may be presented to permit the CCSD to “throw” content to the PDD (e.g., the AVDD 12) either by providing a network link to the content to the PDD, and/or by streaming content directly from the CCSD to the PDD, and/or by causing the PDD to automatically download content from a content source such as a TV station (via cable, satellite, or over the air broadcast), computer network source, etc. without further user interaction.

Note that the above scenario can be symmetrical in that the CCSD may transmit location information and if received by the PDD, in response the PDD may present a UI such as that shown in FIG. 7 on its display to permit the PDD to “throw content” to the CCSD as a companion screen.

Regardless, note that in some embodiments if the user selects the “yes” selector 164 of FIG. 7, a message may be sent from the CCSD to the PDD soliciting use of the PDD as a companion screen to the CCSD. An example of such a message is shown further below.

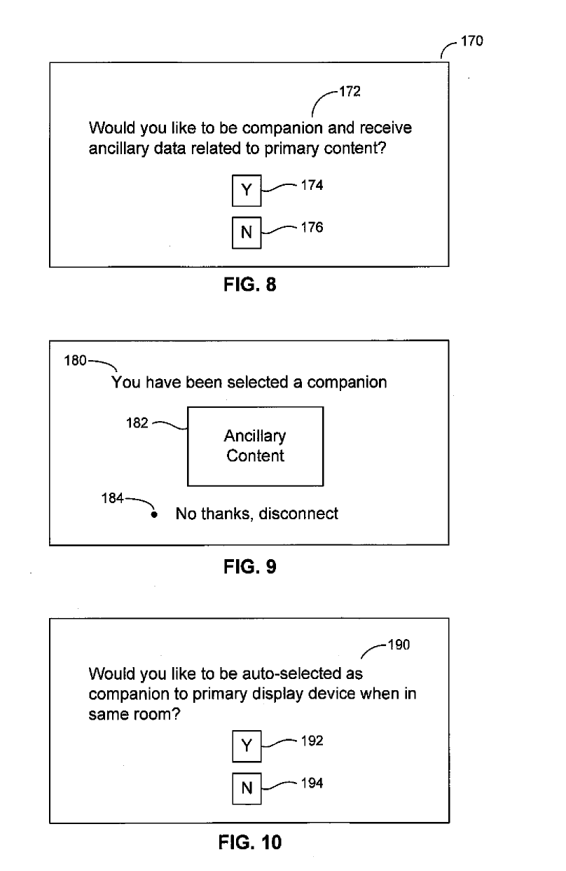

FIG. 8 shows an example UI 170 presenting an example solicitation message 172 on a display 50 of a CCSD which has been selected as a companion screen by a the PDD, it being understood that a PDD may be selected by a CCSD as a companion screen in accordance with present principles as well. In any case, a user may select a “yes” selector element 174 to accept the CCSD to be a companion screen to the PDD, in which case the PDD may send a link to the CCSD to a computer site or broadcast site or other site to download ancillary content or provide the ancillary content itself from data that it is receiving but not displaying on the primary display 14. Or, in response to selecting the selector 174 the CCSD may be caused to automatically and without further user interaction begin downloading the ancillary content as described above. Further, the user can decline to have the CCSD used as a companion device by selecting a “no” selector element 176.

FIG. 9 illustrates a UI that can be presented on a display 50 of a CCSD pursuant to the “automatic linking” described herein. As shown, a message 180 may inform the user of the CCSD that the CCSD has been selected as a companion device, and a window 182 of the display 50 is used to present the ancillary content. A decline selector 184 may be presented which when selected disconnects or otherwise disables, at least temporarily, the CCSD from use as a companion screen to the PDD.

FIG. 10 illustrates an example UI that can be presented on a display 50 of a CCSD in a set-up mode to essentially allow the user to select between the two modes embodied in FIGS. 8 and 9. A message 190 may be presented asking the user if the user would like the CCSD to be subject to automatic selection as a companion screen to a PDD when the CCSD is in the same room as the PDD. A yes selector 192 enables a user to select this feature, while a no selector 194 enables a user to decline automatic selection of the CCSD as a companion screen.

Without reference to any particular figure, it is to be understood that BLE signals in accordance with present principles may be at a transmission power of ten milliWatts or less, so that the likelihood is relatively lower of e.g. a CCSD acquiring location information from a transmitter (e.g. an iBeacon signal transmitter) of location information that e.g. may pertain to a room in which the transmitter is disposed but not a room in which the CCSD is disposed. Further, note that such signals may carry information for location but also for e.g. identifying a network name, and e.g. identifying a location in the home of the PDD as previously programmed by a user such as e.g. “AVDD in living room” or “AVDD in garage.”

It may now be appreciated that UPnP discovery protocol may be modified to include location information. A device discovering another device can determine where the other device is (e.g., living room, den, kitchen, a first bedroom, a second bedroom, etc.). The device can compare the location tag it receives with its own location tag. E.g., if a relatively large smart TV's location tag is “living room” and an advance remote control with its own display also is associated with a location tag for “living room,” it may be determined that both devices are in the same room.

It may also now be appreciated that a device may be able to determine its own location by acquiring an iBeacon signal (e.g. from an iBeacon “beacon”) in a particular room of a structure. The iBeacon “beacon” may be a so-called “standalone” device or may be incorporated into another device such as e.g. a computer or TV mounted on a wall in a living room of a structure. However, it is to be further appreciated that in addition to or in lieu of the foregoing, location information for a device may be input to the device “by hand” based on user input, and/or selected from a group of possible structure locations in accordance with present principles.

Furthermore, if an iBeacon signal is received by a device that contains different location information and/or a different location tag than an earlier-received iBeacon signal, note that location tags that are then transmitted by the device (e.g. at regular and/or predetermined intervals) using UNIT communication to potential companion devices may change to thus reflect the location information in the latter-received signal and hence the e.g. current location of a device that has moved from one room to another.

Before concluding, not also that a location tag in accordance with present principles may be sent out in response to a discovery message from another device (e.g. via UPnP communication).

While the particular PROXIMITY DETECTION OF CANDIDATE COMPANION DISPLAY DEVICE IN SAME ROOM AS PRIMARY DISPLAY USING UPNP is herein shown and described in detail, it is to be understood that the subject matter which is encompassed by the present invention is limited only by the claims.

1. A first device, comprising:
at least one computer memory that is not a transitory signal and that comprises instructions executable by at least one processor for:
determining a physical location of a second device at least partially based on communication of the first device with the second device;
comparing a physical location of the first device to information in a physical location tag of the second device to determine whether the first and second devices are both within a common area;
responsive to determining that the first and second devices are both within the common area, presenting a primary user interface (UI) on a display of the first device, the second device being caused to present a secondary UI responsive to at least one signal from the first device, the secondary UI informing that the second device has been selected as a companion device, the secondary UI including of decline selector selectable to disable the second device from use as a companion screen to the first device.

2. The first device of claim 1, wherein the primary UI enables the user to configure the second device to present ancillary content related to primary content which the first device is to present.

3. The first device of claim 2, wherein the primary UI enables the user to configure the second device to present the ancillary content at least in part by enabling the user to cause a display of the second device to assume a powered on configuration.

4. The first device of claim 2, wherein the primary UI enables the user to configure the second device to present the ancillary content at least in part by enabling the user to indicate a location for the ancillary content which the second device is to access to present the ancillary content.

5. The first device of claim 2, wherein the primary UI enables the user to configure the second device to present the ancillary content at least in part by enabling the user to configure the first device to provide the ancillary content to the second device.

6. The first device of claim 1, wherein the physical location tag is established through a user interface that allows a selection from pre-set location tag choices and/or location tags customized by the user.

7. The first device of claim 1, wherein the physical location of the second device is determined at least in part based on receipt of a location tag from the second device using Universal Plug and Play (UPnP) communication.

8. The first device of claim 7, wherein the location tag that is received includes information pertaining to a room in which the second device is disposed.

9. The first device of claim 1, wherein the physical location of the first device is determined by determining a room in which the first device is disposed.

10. The first device of claim 9, wherein the determining a room in which the first device is disposed is based at least partially on input from a user.

11-15. (canceled)

16. A method, comprising:
enabling communication of physical location information between a first device and a second device, the physical location information pertaining to the location of at least one of the first device and the second device;
responsive to determining at least partially based on the physical location information that the first and second devices are of within a first area, presenting a primary user interface (UI) on a display enabling a user to cause one of the devices to present first content related to but different from second content which the other of the devices is presenting or will be presenting, a secondary UI being presented on one of the devices, the secondary UI including a first selector selectable to subject the device on which the secondary UI is presented to be subject to automatic selection as a companion screen, the secondary UI including a second selector selectable to prevent the device on which the secondary UI is presented to be subject to automatic selection as a companion screen.

17. The method of claim 16, wherein the first content is ancillary content to the second content, wherein the physical location information pertains to the second device, wherein the enabling communication of physical location information between a first device and a second device includes enabling Universal Plug and Play (UPnP) communication, and the enabling and presenting are undertaken at the first device, wherein the display is on the first device, wherein the UI enables the user to cause the second device to present the first content, and wherein the first device is or will be presenting the second content.

18. The method of claim 16, wherein the first content is ancillary content to the second content, wherein the physical location information pertains to the first device, wherein the enabling and presenting are undertaken at the second device, wherein the display is on the second device, wherein the UI enables the user to cause the second device to present the first content, and wherein the first device is or will be presenting the second content.

19. The method of claim 16, wherein the first area is established at least in part based on the dimensions of a room of a structure.

20. The method of claim 17, wherein the determining that the first and second devices are both within the first area is also based at least partially on receipt of at least one Bluetooth low energy (BLE) signal at the first device, the at least one BLE signal including information indicating a room of a structure, the room establishing the first area.

21. A first device, comprising:
at least one computer memory that is not a transitory signal and that comprise instructions executable by at least one processor for:
presenting a primary user interface (UI) on a display of a first device, the primary UI enabling a user to provide a command to a second device to present ancillary content related to primary content which the first device is to present, the second device being caused to present a secondary UI responsive to at least one signal from the first device, the secondary UI informing that the second device has been selected as a companion device, the secondary UI including a decline selector selectable to disable the second device from use as a companion screen to the first device.

22. The first device of claim 21, wherein the instructions are executable for:
determining a physical location of the second device at least partially based on communication of the first device with the second device;
comparing a physical location of the first device to the physical location of the second device to determine whether the first and second devices are both within a common area; and
responsive to determining that the first and second devices are both within the common area, presenting the primary UI on the first device.

23. The first device of claim 22, wherein the primary UI enables the user to configure the second device to present the ancillary content at least in part by enabling the user to cause a display of the second device to assume a powered on configuration.

24. The first device of claim 22, wherein the primary UI enables the user to configure the second device to present the ancillary content at least in part by enabling the user to indicate a location for the ancillary content which the second device is to access to present the ancillary content.

25. The first device of claim 22, wherein the primary UI enables the user to configure the second device to present the ancillary content at least in part by enabling the user to configure the first device to provide the ancillary content to the second device.
